(19) United States
(12) Patent Application Publication
(10) Pub. No.: US 2022/0087213 A1
(43) Pub. Date: Mar. 24, 2022

(54) SMALL REPTILE CAGE AND METHOD OF ASSEMBLY

(71) Applicant: EcoTech, LLC, Bethlehem, PA (US)

(72) Inventors: Timothy MARKS, Northampton, PA (US); Patrick CLASEN, Allentown, PA (US); Christian CLOUGH, Bethlehem, PA (US); Justin LAWYER, Bethlehem, PA (US)

(21) Appl. No.: 17/486,187

(22) Filed: Sep. 27, 2021

Related U.S. Application Data
(63) Continuation-in-part of application No. 16/863,574, filed on Apr. 30, 2020.
(60) Provisional application No. 62/840,760, filed on Apr. 30, 2019.

(51) Int. Cl. A01K 1/03

(52) U.S. Cl. CPC A01K 1/03

(57) ABSTRACT

A cage system in the form of a rectangular box comprises a top member and a bottom member opposing the top member, a front member and a back member opposing the front member and connecting the top and bottom members, and a right member connecting the front and back members and a left member opposing the right member and connecting the front and back members. The back, left and right members are formed separately from each other. The rectangular box further comprises mechanical fasteners or adhesive fastening the back, left and right members to each other. Each of the back, left and right members is made of a single solid sheet material. The front member is divided into a top portion and a bottom portion. The top portion includes a first door hingedly connected to the left or right members and securable to another of the left and right members.

### CROSS REFERENCE TO RELATED APPLICATIONS

The present application is a Continuation-in-Part of U.S. patent application Ser. No. 16/863,574, filed Apr. 30, 2020, which, in-turn, claims the benefit of priority of U.S. Provisional Patent Application No. 62/840,760, filed Apr. 30, 2019, both of which are incorporated herein by reference in their entireties and to which priority is claimed.

### FIELD OF THE INVENTION

This invention relates to an animal cage, particularly for small reptiles such as snakes, lizards, turtles, amphibians, etc. In particular, the cage is lightweight and collapsible to flat components in order to allow shipment in a flat carton and ease of assembly at the point of use.

### BACKGROUND OF THE INVENTION

Many owners, trainers, breeders and veterinarians recommend an animal cage as a convenient and humane tool for raising, training and providing a safe environment for housebreaking, travel, and general control of small animals, such as cats, rabbits, small dogs, hamsters, reptiles, amphibians, etc. Existing cages on the market are of primarily of two designs. The first design includes a six-sided cage made of screen panels made of metal, which assemble individually using aluminum profiles, plastic corner joints, and window screens. The individual window screen panels are then assembled together, holes are pre-drilled, and screws are threaded through the holes to construct a cage assembly. Front doors are fastened to the sides using conventional hinges. This first design is difficult to assemble and fragile, heavy and bulky to ship, and allows the escape of water and moisture from the cage after assembly, making it challenging to maintain a stable environment for the inhabitants.

The second design is a glass cage of either five solid sides (top side open) or six sides with the top being made of screen material and the front being a hinged glass door. This second design is heavy and fragile to ship, and takes up enormous space within the distribution chain. The design is usually limited to only small sizes due to its weight and space requirement.

Therefore, there remains a need for a caging system that resolves issues with the above animal cage designs.

### SUMMARY OF THE INVENTION

A first aspect of the present invention relates to an animal cage, particularly for small animals such as cats, rabbits, small dogs, hamsters, reptiles, amphibians, etc. In particular, the animal cage is lightweight and collapsible to flat components in order to allow easy shipment in a carton and assembly at the point of use. The cage is a six-sided rectangular box with at least a top side and/or a front side being mesh to provide ventilation. The bottom, back, left, and right sides of the cage are made from a single flat sheet of material, preferably corrugated plastic, which is die cut, and contains pre-formed fold lines. Alternatively, only the back, left, and right sides of the cage are made from a single flat sheet of material, preferably corrugated plastic, which is die cut, and contains pre-formed fold lines. The top side and front sides include perimeter frames with mesh or solid material inside the frames. The front side includes a top and bottom portion and provides one or more doors for access to the interior of the cage. The top side preferably includes mesh inside the frame for ventilation. Because the animal cage is constructed mostly of plastic material, it is easy to cut holes into the plastic material for ventilation, drainage, wires, etc.

A second aspect of the present invention relates to a double or multiple cage system. The double cage system is similar to the cage of the first aspect. However, due to the larger size of the cage, additional structural support is provided to maintain the integrity of the assembled structure.

A third aspect of the present invention relates to methods for making the different aspects of the present invention.

According to a fourth aspect of the invention, a cage system is in the form of a rectangular box. The rectangular box comprises a top member and a bottom member opposing the top member, a front member and a back member opposing the front member and connecting the top and bottom members, and a right member connecting the front and back members and a left member opposing the right member and connecting the front and back members. The back, left and right members are formed separately from each other. The rectangular box further comprises mechanical fasteners or adhesive fastening the back, left and right members to each other. Each of the back, left and right members is made of a single solid sheet material. The front member is divided into a top portion and a bottom portion. At least the top portion includes a first door hingedly connected to one of the left and right members and securable to another of the left and right members.

According to a fifth aspect of the present invention, a method for making an animal cage system is disclosed. The method involves the steps of providing separate flat sheets of material cut to provide a left member, a back member and a right member, folding each of the separate flat sheets to form the left, back and right members, fastening the back, left and right members to each other by mechanical fasteners or adhesive, attaching the bottom member to the back, left and right members, attaching a top member to the back, left and right members, attaching rail assemblies on front edges of the left and right members, attaching a divider profile to the rail assemblies on the front edges of the left and right members, the divider profile dividing the front member into a top portion and a bottom portion, and hingedly mounting a first door to one of the rail assemblies so as to form a front member, the first door occupying the top portion of the front member.

Other aspects of the invention, including apparatus, devices, kits, processes, and the like which constitute part of the invention, will become more apparent upon reading the following detailed description of the exemplary embodiments.

### BRIEF DESCRIPTION OF THE DRAWINGS

The foregoing background, as well as the following detailed description, will be better understood when read in conjunction with the appended drawings. For the purpose of illustrating the invention, there is shown in the drawings embodiments which are presently preferred. It should be understood, however, that the invention is not limited to the precise arrangements and instrumentalities shown. In the drawings

FIG. 1 is a perspective view of the assembled animal cage system;

FIG. 2 is a plan view of the corrugated plastic cutout for the cage;

FIG. 3 is a perspective view of the assembled corrugated plastic part;

FIG. 4 is a bottom view of the assembled corrugated plastic part;

FIG. 5 is an exploded view of the assembled corrugated plastic part, the top side, the divider, and lower profiles;

FIG. 6 is an exploded view of the partially assembled cage and the front doors;

FIG. 7 is a perspective view of an alternate embodiment of the assembled animal cage system;

FIG. 8 shows a rack system containing a plurality of stacked cage systems;

FIG. 9 is a perspective view of an external catch tray;

FIG. 10 is a perspective view of the corrugated plastic cutout for a second embodiment of the cage;

FIG. 11 is a perspective view of the assembled corrugated plastic parts of the second embodiment and the bottom side;

FIG. 12 is an exploded view of the partially assembled second embodiment of the cage and the front doors;

FIG. 13 is a perspective view of a double cage embodiment;

FIG. 14 is an exploded view of the assembled corrugated plastic parts of the double cage embodiment;

FIG. 15 is an exploded view of the assembled corrugated plastic part, the top side, the support assembly, and the divider and lower profiles of the double cage embodiment;

FIG. 16 is an exploded view of the partially assembled cage and the front doors of the double cage embodiment;

FIG. 17 shows an exploded view of an exemplary perimeter frame for the top side;

FIGS. 18 and 19 show sectional views of the profile sections of the frame for the top side;

FIGS. 20-21 show sectional views of the profile sections for the frames for the top and bottom portions;

FIGS. 22-23 show sectional views of the profile sections for the right and left rail assemblies; and

FIG. 24 shows a perspective view of the animal cage with a pan forming the bottom side;

FIG. 25 is a perspective view from the front of an assembled animal cage system in accordance with a fourth exemplary embodiment of the present invention;

FIG. 26A is a perspective view from the rear of the assembled animal cage system in accordance with the fourth embodiment;

FIG. 26B is a perspective view from the rear of the assembled animal cage system of FIG. 26A without a perimeter frame

FIG. 27 is a perspective view from the back and bottom of the assembled animal cage system in accordance with the fourth embodiment;

FIG. 28A is a perspective view of a back member, a right member and a left member of the animal cage system in accordance with the fourth embodiment shown separately;

FIG. 28B is a perspective view of the back member, the right side member and the left side member of FIG. 28A shown with hidden lines

FIG. 29A is a plan view of a flat sheet for forming the back member of the animal cage system in accordance with the fourth embodiment;

FIG. 29B is a plan view of a flat sheet for forming the right member of the animal cage system in accordance with the fourth embodiment;

FIG. 29C is a plan view of a flat sheet for forming the left member of the animal cage system in accordance with the fourth embodiment;

FIG. 30 is a perspective view from the front of a double cage system in accordance with a fifth exemplary embodiment of the present invention;

FIG. 31 is a perspective view from the rear of the double cage system in accordance with the fifth exemplary embodiment of the present invention; and

FIG. 32 is a perspective view from the back and bottom of the double cage system in accordance with the fifth exemplary embodiment of the present invention.

### DETAILED DESCRIPTION OF THE PREFERRED EMBODIMENT(S)

The exemplary embodiments of the present invention will now be described with the reference to accompanying drawings. The following description of the preferred embodiment is merely exemplary in nature and is in no way intended to limit the invention, its application, or uses.

For purposes of the following description, certain terminology is used in the following description for convenience only and is not limiting. The characterizations of various components and orientations described herein as being “front,” “back” “vertical”, “horizontal”, “upright”, “right”, ‘left”, “side”, “top”, “bottom”, or the like designate directions in the drawings to which reference is made and are relative characterizations only based upon the particular position or orientation of a given component as illustrated. These terms shall not be regarded as limiting the invention. The words “downward” and “upward” refer to position in a vertical direction relative to a geometric center of the apparatus of the present invention and designated parts thereof. The terminology includes the words above specifically mentioned, derivatives thereof and words of similar import.

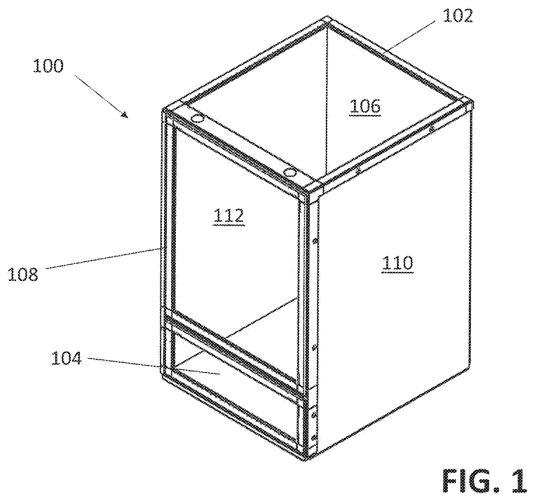

The present invention, as best shown in FIG. 1, is an animal cage system that is constructed of corrugated plastic sheet and extruded aluminum profiles of thin walls. The cage system may be shipped flat in a carton (“knock-down”), is strong and robust, retains a constant environment, and may be manufactured in large and small sizes while taking up very little space within the supply chain. Additionally, due to economically priced materials, the comparative cost is favorable relative to existing solutions. The disclosed cage system is preferably used with small reptiles and non-rodent mammals because many small mammals are rodents, who have a tendency to chew through materials such as used to manufacture the cage system.

Referring to FIG. 1, the animal cage system 100, when assembled, contains a plurality of sides hingedly coupled together. Preferably, the cage system 100 is a rectangular box containing six sides: a top side 102, a bottom side 104, a back side 106, a front side 108, a right side 110, and a left side 112. The back side 106, right side 110, and left side 112 are preferably solid sides, preferably made from corrugated plastic sheet material, preferably about 4 mm in thickness. An exemplary corrugated plastic sheet material is made from polypropylene, such as available from Coroplast®. Coroplast comprises three layers of thin, polypropylene plastic substrate having a zig-zagged layer of plastic sandwiched between two smooth layers of plastic sheeting.

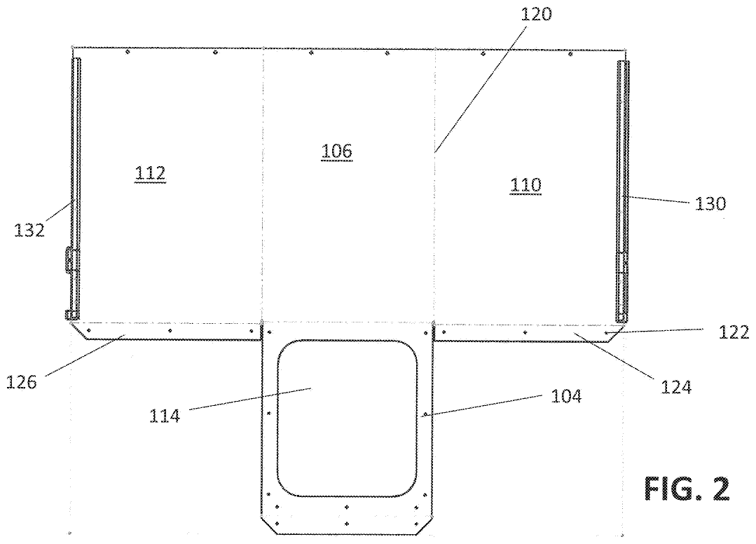

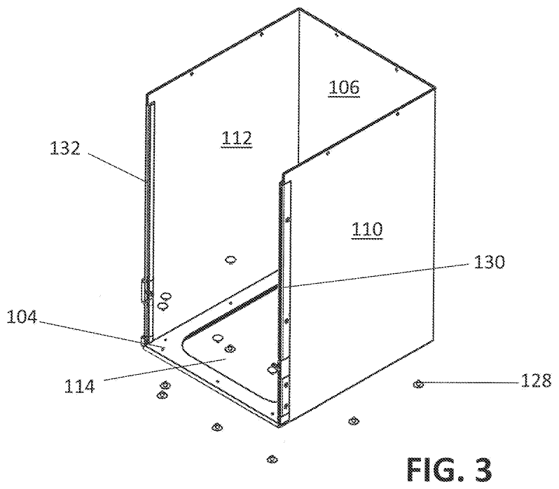

The bottom side 104 may be solid or contain an opening 114 at its center (see FIGS. 2-3) for drainage. The opening 114 preferably occupies an area at least about 50% of the total area of the bottom side 104, more preferably at least 60%, most preferably at least 70%.

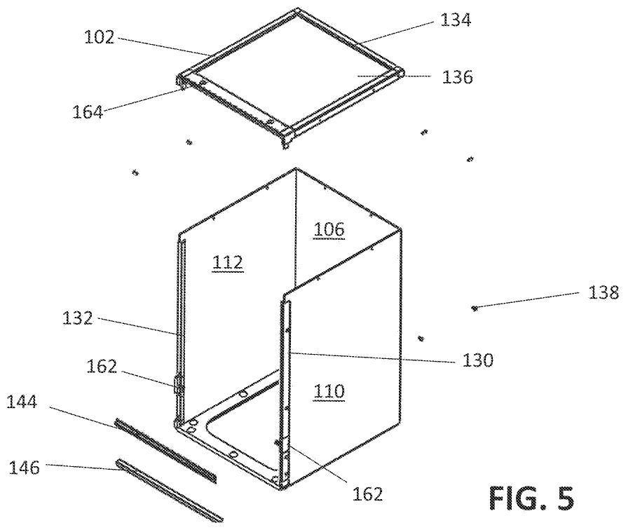

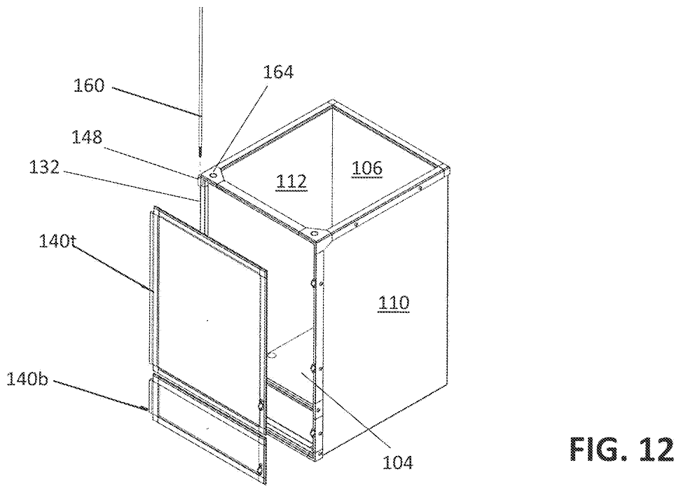

The top side 102 preferably includes a perimeter frame 134 and a mesh screen or plastic material filling the open area 136 inside the frame 134 (see FIG. 5). The frame 134 of the top side may include one or more openings 164 (see FIGS. 5 and 12) formed therein for connecting utilities, such as water or electrical wires to the interior of the cage system 100. The openings 164 are preferably covered, with a plug or a press-out material until the openings 164 are needed.

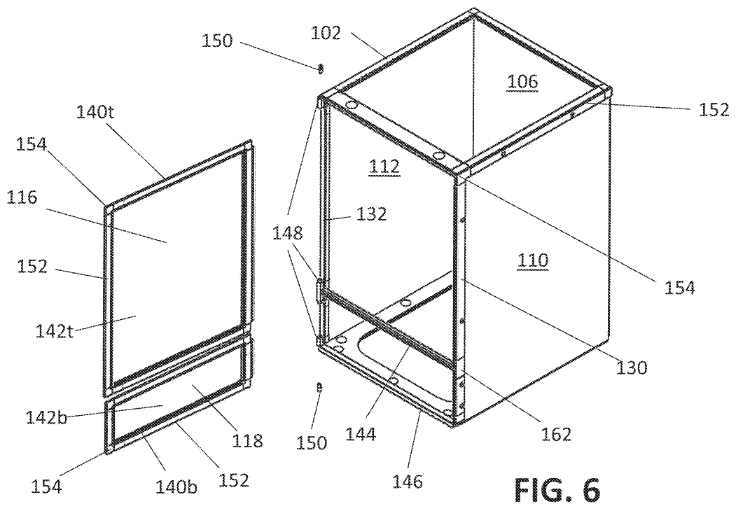

The front side 108 preferably contains a top portion 116 and a bottom portion 118 (see FIG. 6). The top portion 116 is typically larger than bottom portion 118 to allow ease of access to the interior of cage system 100. For example, the top portion 116 has an area at least twice that of the bottom portion 118. The top portion 116 includes a perimeter frame 140t and either a mesh screen or clear material, such as glass or plastic, filling the open area 142t inside the frame 140t. The bottom portion 118 includes a perimeter frame 140b and either a mesh screen or a clear material, such as glass or plastic, filling the open area 142b inside the associated the frame 140b. Both the top and bottom portions 116 and 118 may contain mesh screens within open areas 142t and 142b; both the top and bottom portions 116 and 118 may contain glass within open areas 142t and 142b; the top portion 116 may contain a mesh screen while the bottom 118 contains glass within open areas 142t and 142b, respectively; or the top portion 116 may contain glass while the bottom 118 contains a mesh screen within open areas 142t and 142b respectively. The mesh screen making up one or more of the sides provides ventilation for the cage system 100. The perimeter frames 140t, 140b, or 134 are preferably made from linear profile sections 152, preferably extruded aluminum profiles, that may be connected together with corner joints 154, preferably made from injection-molded plastic.

In a first embodiment, the bottom, back, left, and right sides 104, 106, 110, and 112, respectively, are made from a single flat sheet of material 101, preferably corrugated plastic such as Coroplast, which is die cut, and contains pre-formed fold lines 120, as best shown in FIG. 2, forming seams to allow folding of the corrugated sheet 101 into a four-sided structure (see FIG. 3). In certain embodiments, holes 122 are formed in the corrugated plastic sheet 101 for connection of the associated sides with mechanical fasteners, such as rivets, screws, nuts/bolts, etc., and/or adhesive. The right and left sides 110 and 112 may include flange portions 124 and 126, respectively, to allow the right and left sides 110 and 112 to be connected to the bottom side 104, such as with mechanical fasteners and/or adhesive. Attached to the left and right sides 110 and 112 are the vertical rail assemblies 130 and 132, respectively, preferably made from extruded aluminum profile sections and/or injection molded plastic parts. The rail assemblies 130 and 132 are used to attach the front side 108 to the cage system 100, as noted below.

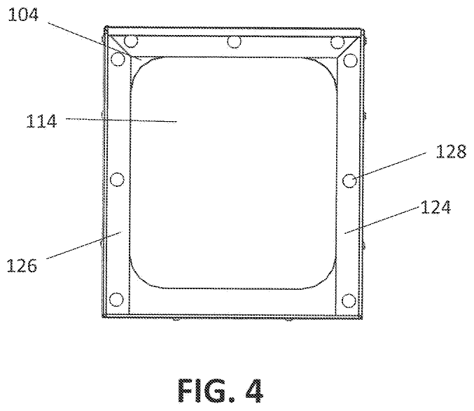

To assemble the first embodiment of the cage system 100, the flat sheet 101 (as shown in FIG. 2) is folded along fold lines 120 to form the bottom, back, left, and right sides 104, 106, 110, and 112 (see FIG. 3). Mechanical fasters 128 may be placed through holes 122 prior to folding in order to hold the sides together (see FIGS. 3 and 4) during assembly. Alternatively, the sides 104, 106, 110, and 112 may be folded, the profiles 152 located at the associated fold lines and then the fasteners inserted in sequential fashion; i.e., a profile secured to the fold line 120 between sides 106 and 110, and then a profile secured at the fold line 120 between sides 112 and 106.

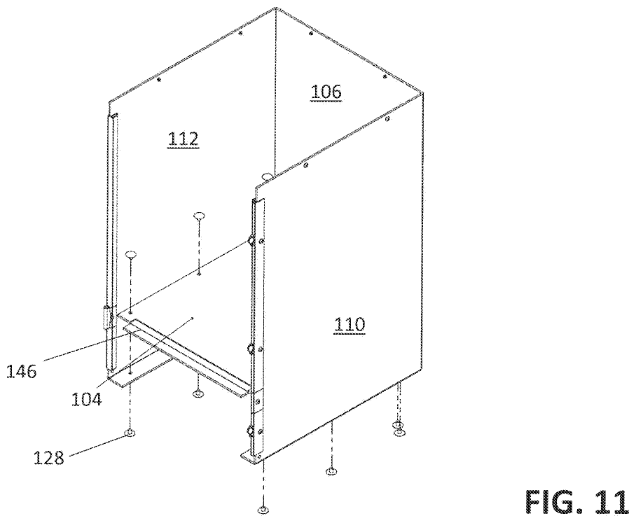

The top side 102 may then be attached to the thus assembled structure (see FIG. 5). The frame 134 of the top side 102 is attached to the back, right, and left sides 106, 110, and 112, respectively, with adhesive and/or fasteners 138. Alternatively, an adhesive may be used instead of or in addition to the fasteners 138. A divider profile 144 is attached to the rail assemblies 130 and 132, as best shown in FIG. 6, to divide the front opening into top and bottom sections. The top section accommodates the top portion 116 of the front side 108 and the bottom section accommodates the bottom portion 118 of the front side 108. Preferably, the divider profile 144 is held in place by friction from a press-fit mating part 162 (preferably made by injection molding of plastic) on the rail assemblies 130 and 132, such as provided by a spring loaded male fitting that mates with a female fitting attached to rail assembly 130, and/or by one or more fasteners. A lower profile 146 slides over a lowest hem joint of the folded corrugated plastic assembly and is held in place by friction or by a pre-designed spring force of the lower profile 146 itself, as shown in FIGS. 5 and 6. A hem joint is simply a facet of the corrugated plastic sheet of the bottom side 104 of the box 100 that is folded back upon itself. The hem joint is used to provide additional strength. However, the hem joint may not be used in the animal cage system 100, as shown in FIG. 11. Alternatively, the ends of the lower profile 146 may be attached to the right and left sides 110 and 112, respectively, by mechanical fasteners at the corners formed by the bottom side 104 and the right side 110 and by the bottom side 104 and the left side 112. The lower profile 146 prevents the lowest hem joint from bowing and preserves the structural integrity of the cage system 100.

The top and bottom portions 116 and 118 of the front side 108 are then attached to form doors (see FIG. 6) for the cage assembly 100. The top and bottom portions 116 and 118 slide into place over hinge positions 148 located on the rail assembly 132. As best shown in FIG. 12, a single metal hinge pin 160 traverses all three hinge positions 148 to hingedly attach the top and bottom portions to the rail assembly 132. Alternatively, metal hinge pins 150 are threaded down from above and up from the bottom into the top and lower hinge positions, respectively, to secure the of the top and bottom portions 116 and 118. In another alternative, a pintle may extend downwardly from frame 134 to fit within a hinge opening integral with upper frame 140t. A pintle may also extend upwardly from the lower profile 146 to fit with a hinge opening formed in lower frame 140b. Once assembled, the top and bottom portions 116 and 118 form doors for the cage system 100. The doors may be opened by pivoting the top or bottom portion 116 or 118 about its hinge attachment to the rail assembly 132. Opposing the hinge attachment, the door for portions 116 and 118 may contain a latching mechanism for securing the door in a closed position. Common latching mechanisms are well-known to a skilled person in the art. Although the drawings show the hinge positions 148 located on the rail assembly 132, the hinge positions 148 may be located on the opposing rail assembly 130.

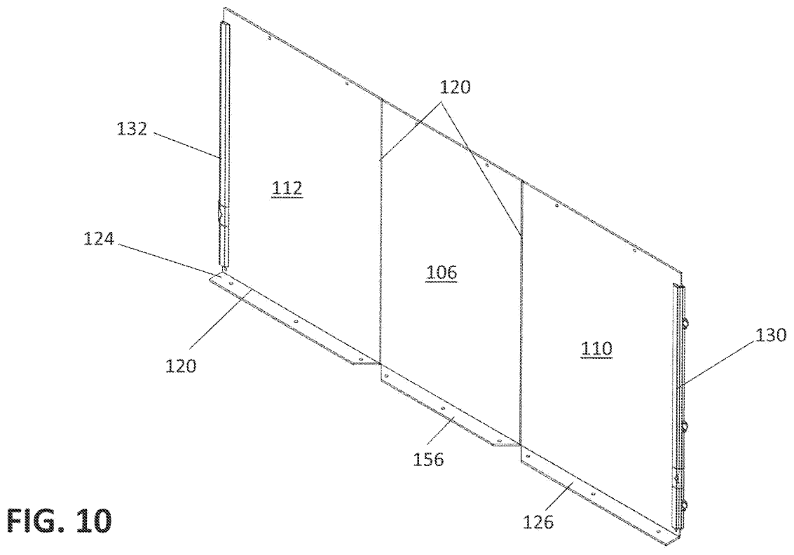

In a second embodiment, as best shown in FIG. 10, the back, left, and right sides 106, 110, and 112, respectively, are made from a single flat sheet of material, preferably corrugated plastic such as Coroplast, which is die cut, and contains pre-formed fold lines 120. Because the bottom side 104 is not included in the flat sheet, the back side 106 may also include a flange portion 156 at the bottom for attachment of bottom side 104. As described above, the right and left sides 110 and 112 also include flange portions 124 and 126, respectively, and vertical rail assemblies 130 and 132, respectively.

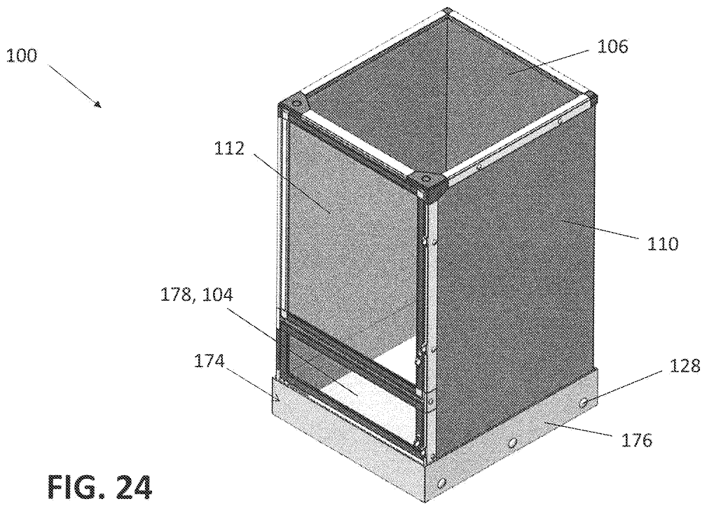

As best shown in FIG. 11, the bottom side 104 is made from a sheet of material, preferably corrugated plastic, and attached to the flange portions 124, 126, and 156 by adhesive and/or mechanical fasteners 128, such as rivets, nuts/bots, screws, clips, or combinations thereof. The bottom side 104 may be solid or contain an opening, as disclosed above for the first embodiment. Alternatively, the bottom side 104 may include a pan 174 attached to the cage 100 (see FIG. 24). The rest of the cage 100 (without a bottom side 104) may be placed inside the pan 174, so that the bottom 178 of the pan 174 itself forms the bottom side 104. The pan 174 may contain raised walls 176 that can be attached to the right, back, and/or left side(s) 110, 106, 112 with mechanical fasteners 128 and/or adhesive. The pan may be made of an extruded or molded plastic or metallic material or glass material. If a pan 174 is used to form the bottom side 104, a lower profile 146 is not needed.

The top and front sides 102 and 108 of the second embodiment are substantially similar to the top and front sides 102 and 108 of the first embodiment. Once assembled, the second embodiment provides a substantially similar cage system 100 to the first embodiment (see FIG. 12).

To assemble the second embodiment of the cage system 100, the flat sheet (as best shown in FIG. 10) is folded along fold lines 120 to form the back, left, and right sides 106, 110, and 112, respectively, of the cage assembly 100 (see FIG. 11). The bottom side 104 is then attached to the flange portions 156, 124, and 126 with one or more mechanical fasteners 128 (see FIGS. 11 and 12) and/or adhesive. The top and front sides are then attached as described above for the first embodiment.

The rail assemblies 130 and 132, and the frames 134, 140t, and 140b are preferably made from linear profile sections 152 connected at the corners by joints 154. The profile sections 152 may be made of aluminum or plastic, preferably extruded aluminum; and the joints may be made of injection molded plastic. The profile sections 152 and joints 154 may be formed by extrusion, molding, or other methods known in the art. The one or more openings 164 in the frame 134 of the top side 102 may be formed on the profile sections 152, as shown in FIG. 5, or the joints 154, as shown in FIG. 12. Because the profiles 152 are extruded aluminum, they provide structural strength, are lightweight, and occupy relatively little space when shipped in a carton.

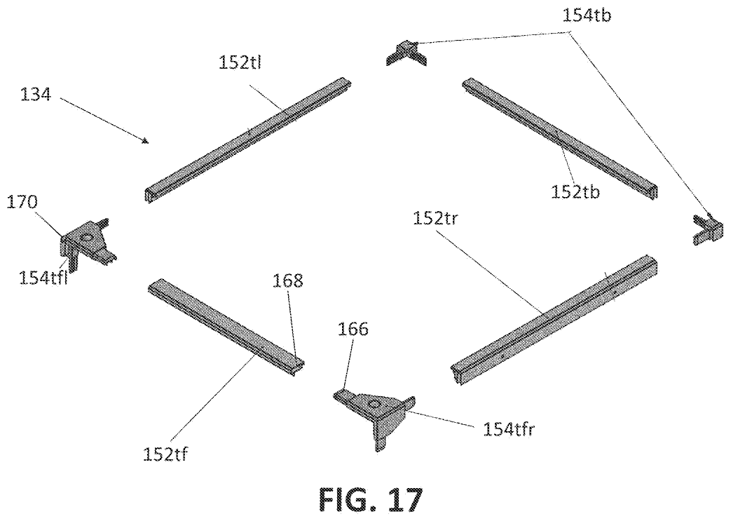

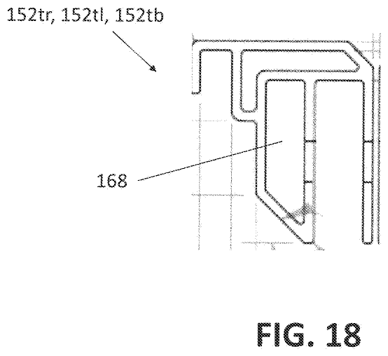

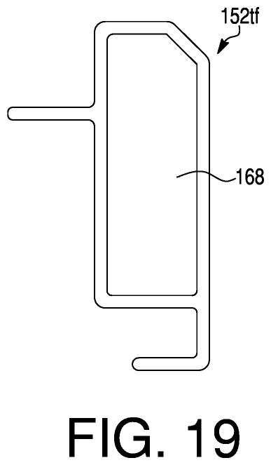

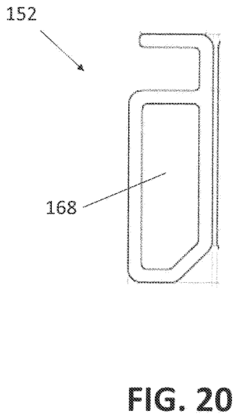

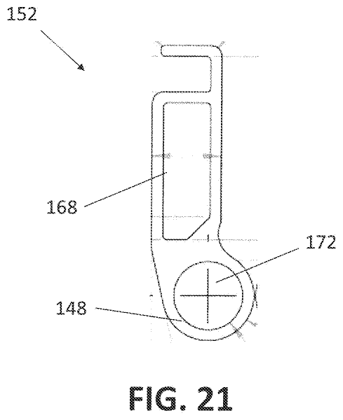

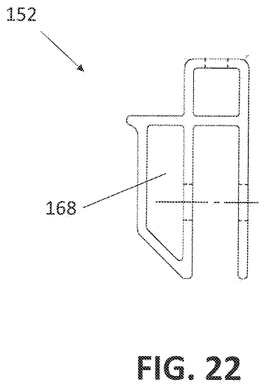

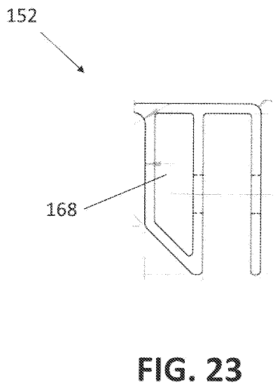

FIG. 17 shows an exemplary perimeter frame 134 for the top side 104. The frame 134 includes two front corner joints 154tfl and 154 tfr and two back corner joints 154tb. The joints 154tfl, 154t1r, and 154tb include one or more press-fit inserts 166 that are configured to fit into openings 168 of profile sections 152. The back corner joints 154tb are mirror images of each other, while the front corner joints 154tfl and 154tfr differs from each other. The front corner joint 154tfl includes a hole 170 for accommodating the hinge pin 150 or 160 forming the hinge position 148. As shown in FIG. 17, the frame 134 includes four profile sections, 152tf, 152tr, 152t1, and 152tb. The cross-section of the profile sections may be different from each other and depend on the shape of the insert(s) 166 to which the profile section mate. For example, as shown in FIG. 17, the cross-section for profile sections 152tr, 152t1, and 152tb are identical (see FIG. 18), but different from the cross-section for the profile section 152tf (see FIG. 19), due to the different functional and connection requirements of the individual profile section. FIG. 18 shows an exemplary cross-section for profile sections 152tr, 152t1, and 152tb; and FIG. 19 shows an exemplary cross-section for profile section 152tf. Other joints 154 and profile sections 152 may be utilized based on their respective functional and connection requirements. For example, FIGS. 20-21 show the cross-section of the profile sections 152 for the frames 140t and 140b. The profile shown in FIG. 21 forms the hinge side of the frame 140t or 140b where the hole 172 accommodates the hinge pin 150 or 160. FIGS. 22-23 show the cross-sections of the right and left rail assemblies 130 and 132, respectively.

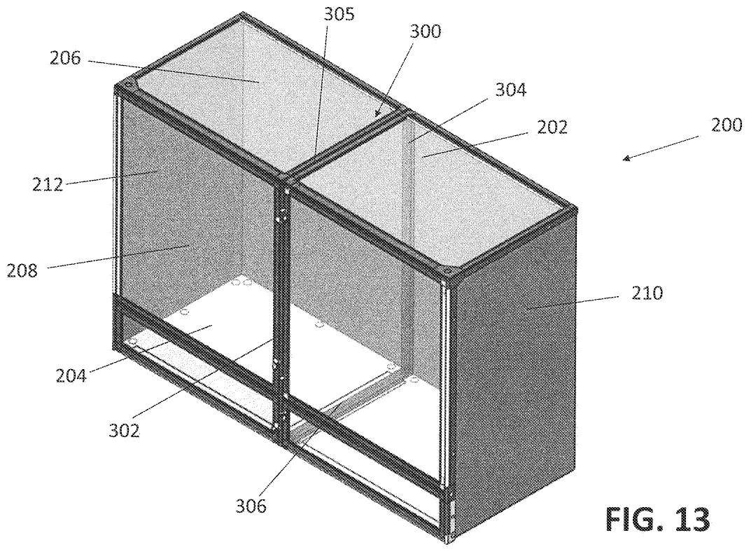

FIGS. 13-16 show a third embodiment of the present invention, referred to herein as the double cage system 200. As best shown in FIG. 13, the double cage system 200 is similar to the other embodiments in that it provides a six-sided a rectangular box containing: a top side 202, a bottom side 204, a back side 206, a front side 208, a right side 210, and a left side 212. The back side 206, right side 210, and left side 212 are solid sides, preferably made from corrugated plastic sheet material of about 4 mm in thickness. The double cage system 200, however, is larger than the other embodiments and additional structural support is provided to maintain structural integrity of the assembled structure. The double cage system 200 contains similar structures as disclosed for the first and second embodiments. Where similar structures exist, the numerical references for similar structures have the same last two digits, with the reference numerals for the double cage system 200 having 2 as the first digit, while the reference numerals for the first and second embodiments includes 1 as the first digit. For example, the left and right sides 212 and 210 of the double cage system 200 corresponds to the left and right sides 112 and 110 of the first and second embodiments. Additional structures including in the double cage system 200 (which have no corresponding structures in the first and second embodiments) are referred to with numerals having 3 as the first digit.

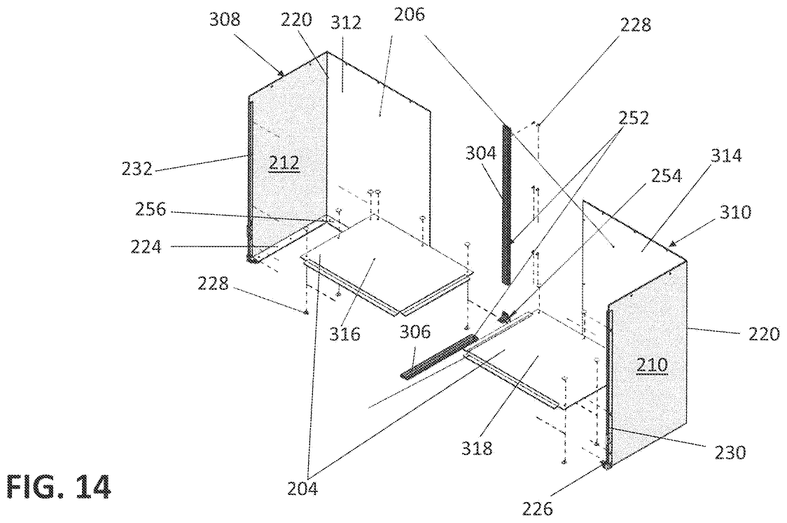

In addition to the structures similar to those disclosed above for the first and second embodiments, the double cage system 200 includes a center support assembly 300, dividing the cage 200 into left and right portions (see FIG. 13). The center support assembly 300 includes extruded aluminum profile sections providing a front support 302, a back support 304, a top support 305, and a bottom support 306. The front and back supports 302 and 304, respectively, are preferably parallel to each other; and the top and bottom supports 305 and 306 are preferably parallel to each other. The bottom support 306 connects the bottom ends of the front and back supports 302 and 304; and the top support 305 connects the top ends of the front and back supports 302 and 304. The center support assembly 300 may be formed, as described above for the frames 140t, 140b, and 134, with linear profile sections 252 connected at the corners by injection molded plastic joints 254 (see, e.g., FIG. 14).

The back support 304 provides support for the back side 206, and is preferably aligned vertically at the center of the back side 206, extending from the topside 202 to the bottom side 204. The back support 304 may be attached to the back side 206 with one or more mechanical fasteners and/or adhesive.

The bottom support 306 provides support for the bottom side 204, extending from the back side 206 to the front side 208. Like the back support 304, the bottom support 306 may be attached to the bottom side 204 with one or more mechanical fasteners and/or adhesive.

The top support 305 provides support for the top side 202, extending from the back side 206 to the front side 208. Like the bottom support 306, the top support 305 may be attached to the bottom side 204 with one or more mechanical fasteners and/or adhesive.

The front support 302 provides support for the front side 208, and is preferably aligned vertically at the center of the front side 208, extending from the topside 202 to the bottom side 204. More specifically, the front support 302 has the critical purpose of providing a profile for the door's lock latches to rivet into. When the door is shut, the lock lathes are pivoted to prevent the door from opening. It also provides a positive “stop” for the door and closes any gaps around the door to prevent animals from escaping.

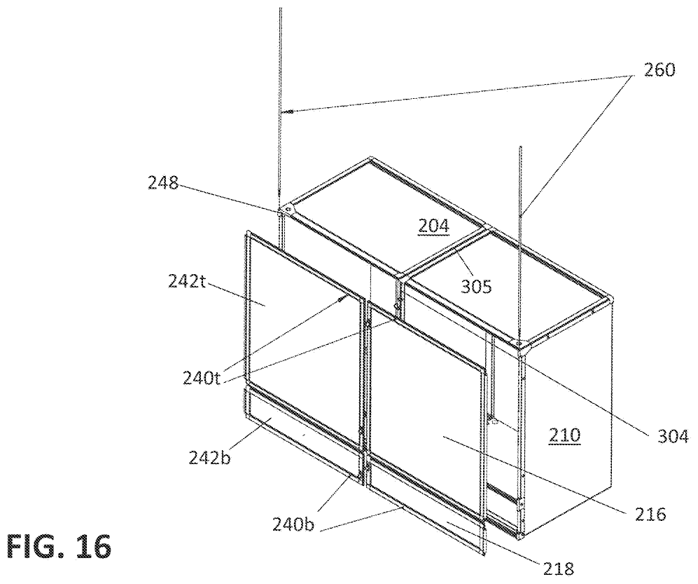

The front support 302 divides the front side 208 into a left half and a right half. Each of the left and right halves has a top portion 216 and a bottom portion 218 that are similar to and have the same general construction as the top and bottom portions 116 and 118 of the first and second embodiments (see FIGS. 13 and 16). As best shown in FIG. 16, the top portion 216 includes a perimeter frame 240t and either a mesh screen or clear material, such as glass or plastic, filling the open area 242t inside the frame 240t. The bottom portion 218 includes a perimeter frame 240b and either a mesh screen or a clear material, such as glass or plastic, filling the open area 242b inside the associated the frame 240b. The top and bottom portions 216 and 218, respectively, form doors that pivot on their hinges. On the left half, the top and bottom portions 216 and 218 are hingedly attached to the rail assembly 232 on the left side 212; on the right half, the top and bottom portions 216 and 218 are hingedly attached to the rail assembly 230 on the right side 210. The doors 216 and 218 may open and close by pivoting on hinges on the rail assemblies 232 and 230. Closure of the doors occurs by latching them to the front support 302.

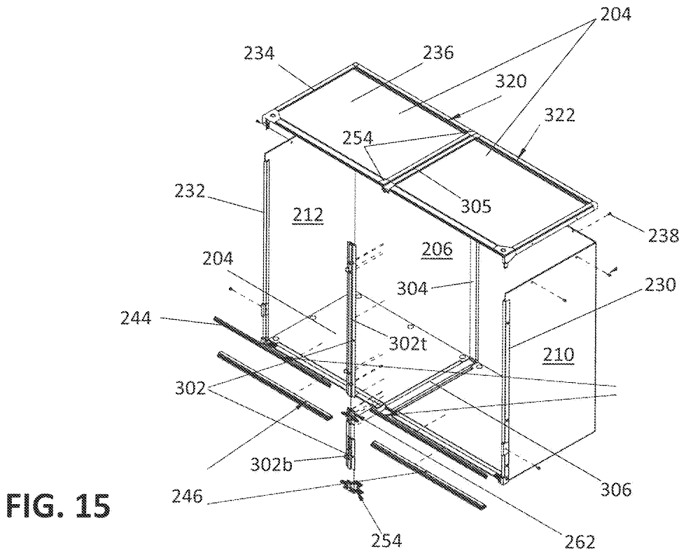

The front support 302 also includes a press-fit mating part 262 for attachment of divider profiles 244 thereto (see FIG. 15). Each of the left and right halves include a divider profile 244 attached to the rail assembly 230 or 232 and the front support 302 to divide each of the left and right halves into top and bottom sections. The top section accommodates the top portion 216 and the bottom section accommodates the bottom portion 218 (see FIG. 16).

The back, right, and left sides 206, 210, and 212, respectively, are made from two sheets of corrugated plastic sheet material (Coroplast), as shown in FIG. 14, which are die cut, and contain pre-formed fold lines 220. A left sheet 308 forms the left side 212 and a left part 312 of the back side 206; and a right sheet 310 forms the right side 210 and a right part 314 of the back side 206. The two sheets 308 and 310 are joined by the back support 304, preferably with one or more mechanical fasteners 228 (see FIG. 14). Because the bottom sides 204 are not included in the flat sheets, the left, back, and right sides 212, 206, and 210, respectively, include flange portions 224, 256, and 226 at their bottom edges for attachment of the bottom side 204. As described above, the right and left sides 210 and 212 also include vertical rail assemblies 230 and 232, respectively. Once folded, the back support 304 completes the back side 206 by joining the left and right parts 312 and 314 of the back side 206.

The bottom side 204 may be attached, in a single piece, as described above for the first and second embodiments. Alternatively, as best shown in FIG. 14, the bottom side 204 preferably includes two parts: a left part 316 and a right part 318. The left and right parts 316 and 318 of the bottom side 204 are joined by the bottom support 306. Preferably, the left and right parts 316 and 318 slide into channels in the bottom support 306 and are retained therein by friction. Alternatively, the left and right parts 316 and 318 may be attached to opposing sides of the bottom support 306 by one or more mechanical fasteners and/or adhesive. The bottom side 204 is secured in place by attachment to the flanges 224, 256, and 226 of the left side 212, back side 206, and right side 210, respectively, preferably by mechanical fasteners 228 and/or adhesive. Each of the left and right parts 316 and 318 of the bottom side 204 includes a lower profile 246 (see FIG. 15) at its front edge to prevent the lowest hem joint from bowing and to preserve structural integrity of the cage system 200. The lower profile 246 is held in place in a similar manner as that of the lower profile 146 described above for the first and second embodiments.

The top side 202 may be attached, in a single piece, as described above for the first and second embodiments. Alternatively, as shown in FIG. 15, the bottom side 204 preferably includes two parts: a left part 320 and a right part 322. Each of the left and right parts 320 and 322 includes a perimeter frame 234 and a mesh screen or plastic material filling the open area 236 inside the frame 234. The left and right parts 320 and 322 are joined at one side of their respective perimeter frame 234, by mechanical fasteners and/or adhesive. The joined topside 202 is then attached to the left, back, and right sides 212, 206, and 210, preferably by mechanical fasteners 238 and/or adhesive. The joined seem between the left and right parts 320 and 322 of the top side 202 forms the top support 305 which is connected to the back support by a joint 254.

As best shown in FIGS. 13 and 15, the front support 302 divides the front side 208 into a left half and a right half and includes two linear profiles, a top profile 302t and a bottom profile 202b, connected by the mating part 262. The mating part 262, as described above, also provides connections for the divider profiles 244. The top end and bottom ends of the front support 302 are attached to the top support 305 and the bottom support 306, respectively, by joints 254.

As shown in FIG. 16, doors for the top and bottom portions 216 and 218 are hung on the left and right assemblies 232 and 230 as described above. Preferably, a single metal hinge pin 260 traverses all three hinge positions 248 to hingedly attach the doors 216 and 218 to the rail assembly 132 (see FIG. 16).

Once assembled, the cage systems 100, 200 is a six-sided cage featuring a screened top and a screened front door(s) for ventilation. These screened doors and top may easily be replaced with any combination of screen or solid plastic or glass material as the intended use requires for maintaining proper environment within the cage system 100, 200.

As a result of the use of corrugated plastic, the present animal cage systems 100, 200 are significantly lighter than glass cages, but retain moisture within the interior environment. They also do not crack as may occur with a glass cage. The cages 100, 200 may be modified to incorporate additional ventilation or mounting holes by cutting or drilling the plastic sheet as the user sees fit.

Another benefit of the corrugated plastic sheet is that it can be digitally printed on. Therefore, the cage system 100, 200 can be made available with pre-printed forest, jungle, desert, or any other type of scene that is desired, pre-printed onto the inside of the cage. This has the advantage of calming the inhabitant(s) of the cage with a natural look, and making decorating the cage easier for the owner. Corrugated plastic is also easy to disinfect, has a high melting temperature, and is very robust.

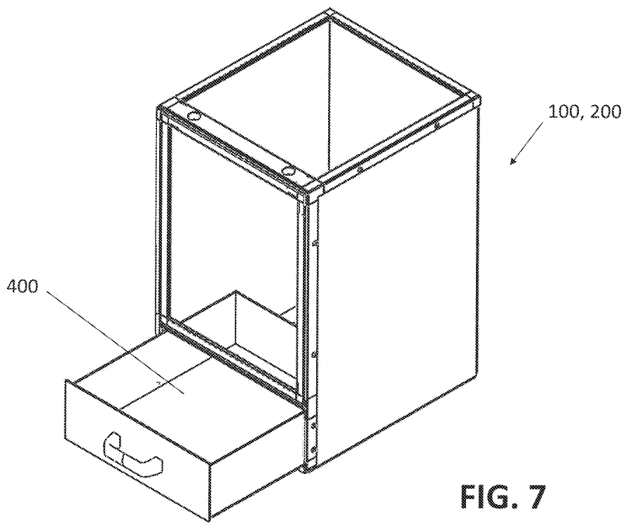

In certain embodiments, in place of the lower door in the bottom portion 118 of the front side 108, a sealed five-sided tray 400 may be present (see FIG. 7). The tray 400 is configured to contain water, food, soil, or other substrate for the animal, without allowing such water, food, soil, or other substrates to escape from the cage system 100, 200. The tray 400 is also configured for slidable insertion into and removal from the bottom of the of the cage system 100, 200 to allow for periodic cleaning, and/or replacement of water, food, soil, or other substrates. The tray 400 may be made from corrugated plastic (folded from a single sheet or assembled from individual panes of sheet) or thermoformed materials. When used with the double cage system 200, each half of the cage system 200 includes a tray 400, so that the cage system 200 includes two trays in its front side 208.

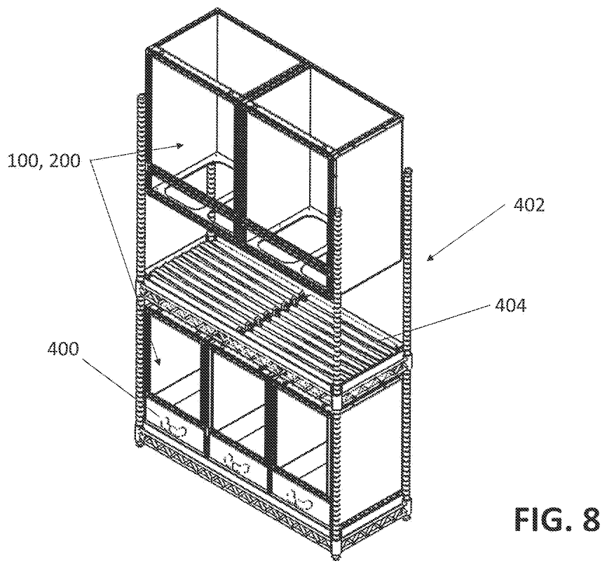

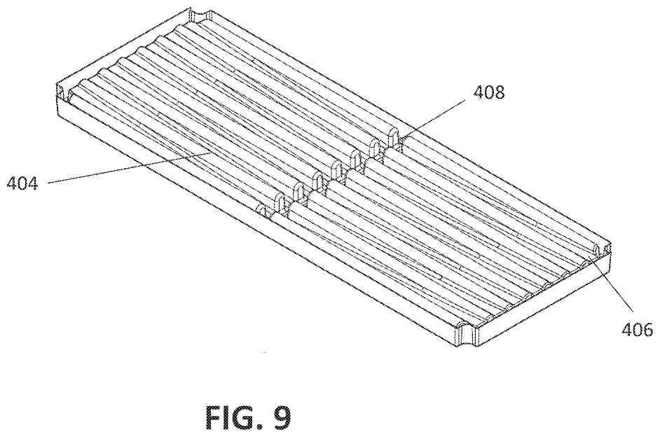

As illustrated in FIG. 8, a plurality of cage systems 100, 200 may be stacked onto a rack system 402. FIG. 8 shows the top cage systems 100, 200 lifted to expose one or more external catch trays 404 located directly below the cage systems 100, 200. In use, the cage system(s) 100, 200 are lowered directly on top of and in contact with the catch trays 404. The catch trays 404 may be used with cage systems 100, 200 having an opened bottom side 104, 204 for catching water, food, soil, or other substrates for the animal. The catch trays 404 may be configured to fit a single or multiple cages 100, 200, respectively, within a rack system 402. The rack system 402 preferably is formed by interconnected metal sections extending horizontally and vertically, resembling metal shelving, in order to accommodate and seat the cages 100, 200. Preferably, the catch tray 404 is optimized to fit within standardized rack systems, allowing multiple cages 100, 200 to be nested together to save space. Preferably, the catch tray 404 contains sloped surfaces 406 (see FIG. 9) to channel water to a point where a drain hole and/or valve (not shown) is installed for drainage. For example, as shown in FIG. 9, the surfaces 406 are sloped toward the center of the catch tray 404, so that water is directed to a center drainage channel 408 which contains a drainage hole and/or valve (not shown). The catch tray 404 may be made from folded corrugated plastic (from individual panes of sheet) or thermoformed materials, with the thermoformed materials being preferred.

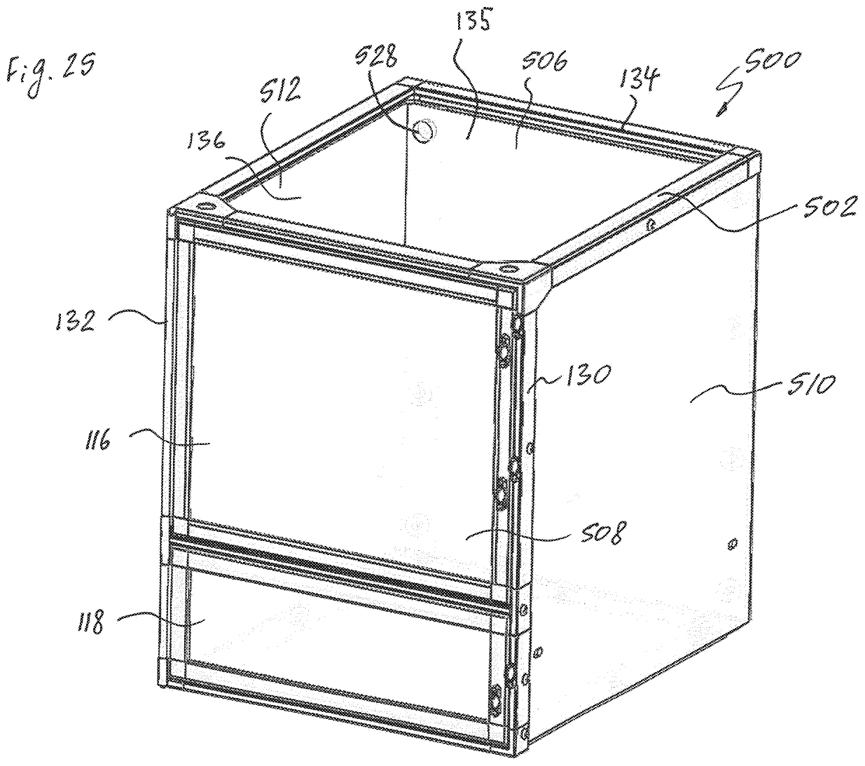

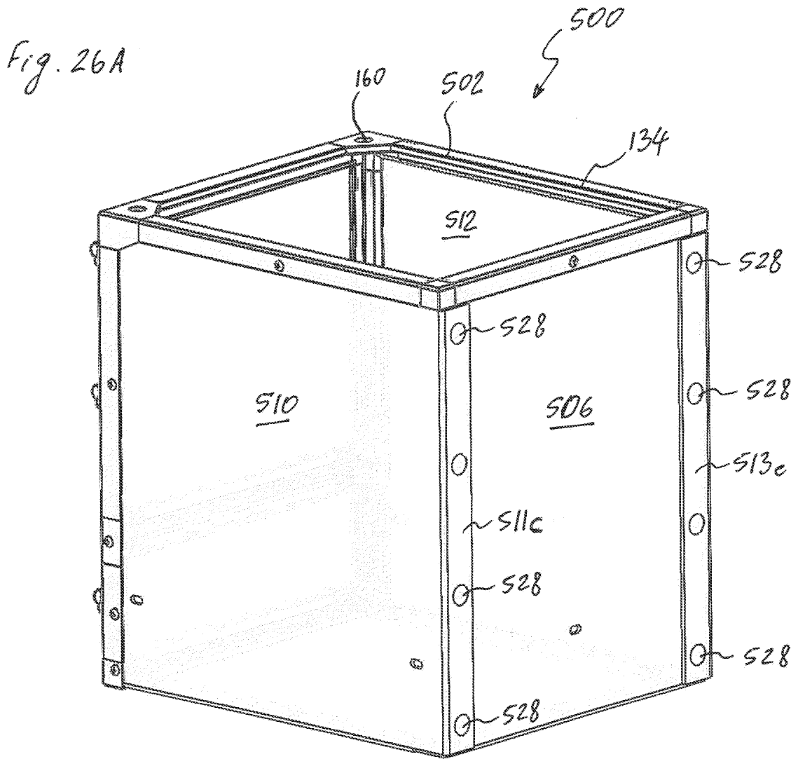

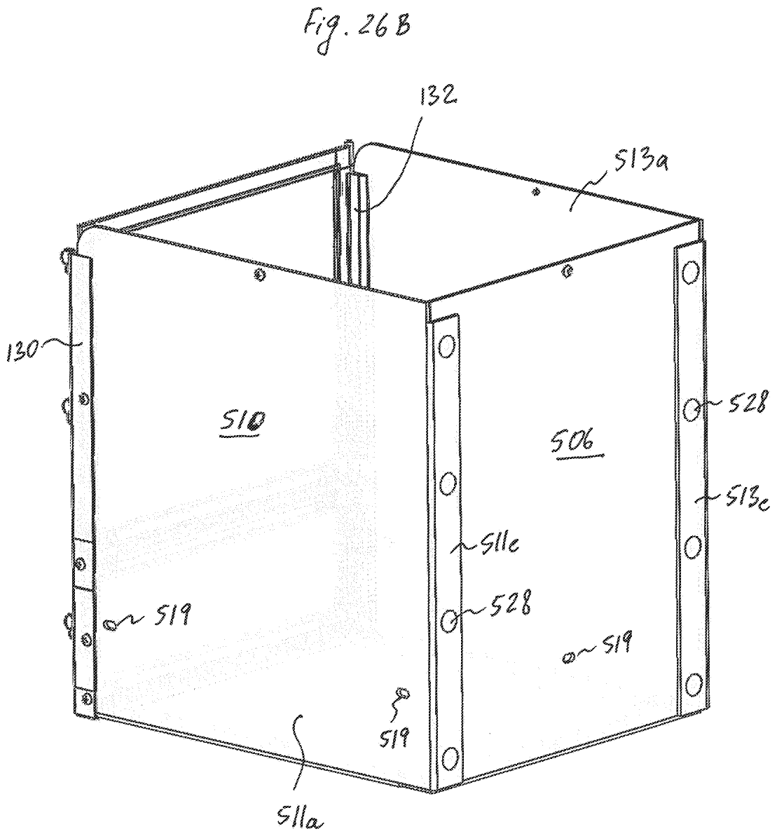

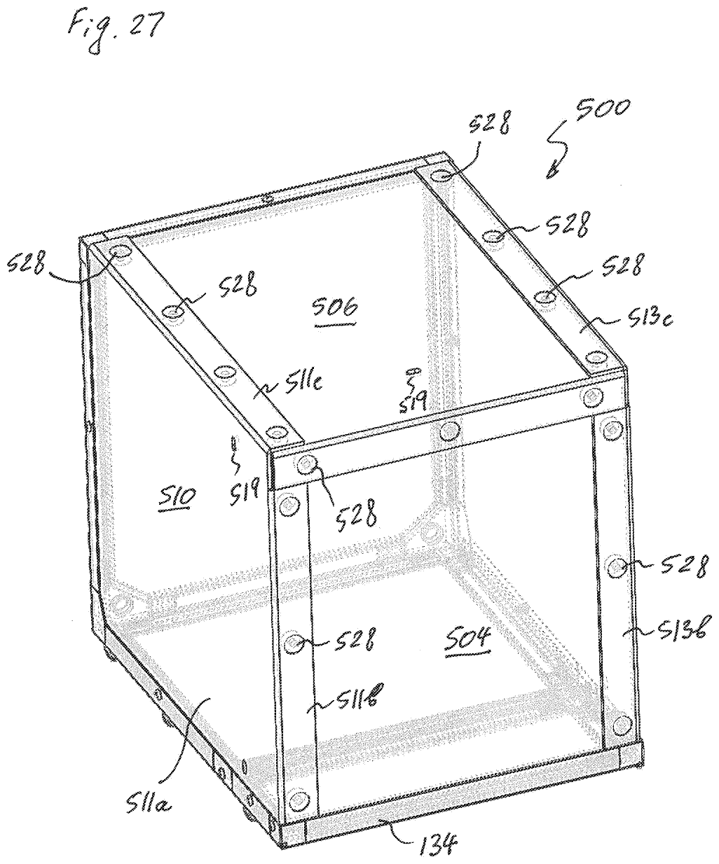

FIGS. 25-29C show an animal cage system (or habitat) 500 according to a fourth exemplary embodiment. The animal cage system 500 is similar to the animal cage system 100 best shown in FIGS. 1 to 6. In the interest of brevity, reference characters in FIGS. 25-29C that are discussed above in connection with FIGS. 1-24 are not further elaborated upon below, except to the extent necessary or useful to explain the additional embodiments of FIGS. 25-29C. Modified components and parts are indicated by the addition of four hundred to the reference numerals of the components or parts according to the first exemplary of the present invention.

The animal cage system 500, when assembled, is a six-sided rectangular box including a top member (or top side) 502, a bottom (or base) member (or bottom side) 504, a back member (or back side) 506, a front member (or front side) 508, a right member (or right side) 510 and a left member (or left side) 512. The back side 506, right side 210, and left side 212 are solid sides, preferably made from corrugated plastic sheet material of about 4 mm in thickness such as Coroplast. Each of the base member 504, the back member 506, the right member 510 and the left member 512 are formed separately from each other and fastened to each other during assembly of the animal cage system 500 by appropriate means, e.g., mechanical fasteners, such as rivets, screws, nuts/bolts, etc., and/or adhesive. The front member 508 is structurally similar to the front side 108 of the animal cage system 100 according to the first embodiment best shown in FIGS. 1 to 6.

The back member 506, right member 510, and left member 512 are preferably made from solid sheets of a plastic material. An exemplary corrugated material is made from a corrugated polypropylene, such as available from Coroplast®. Coroplast® comprises three layers of thin, polypropylene plastic substrate having a zig-zagged layer of plastic sandwiched between two smooth layers of plastic sheeting.

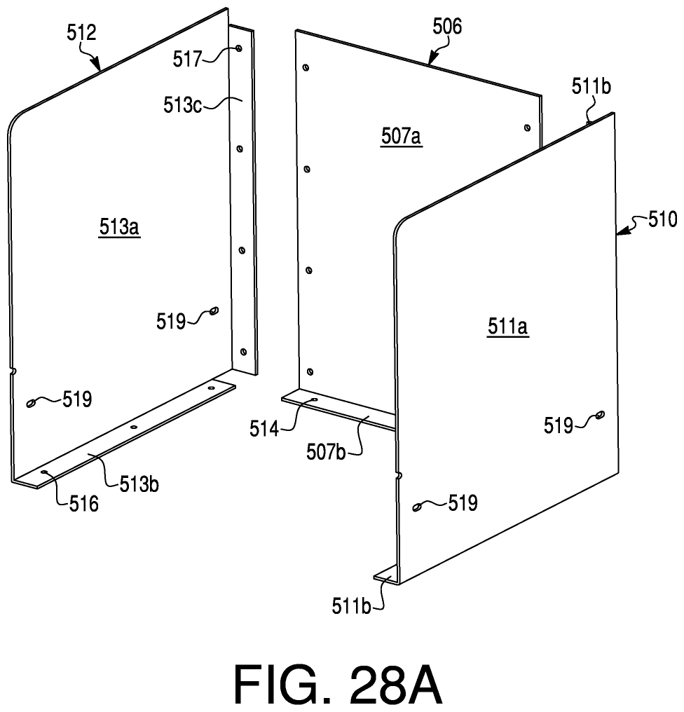

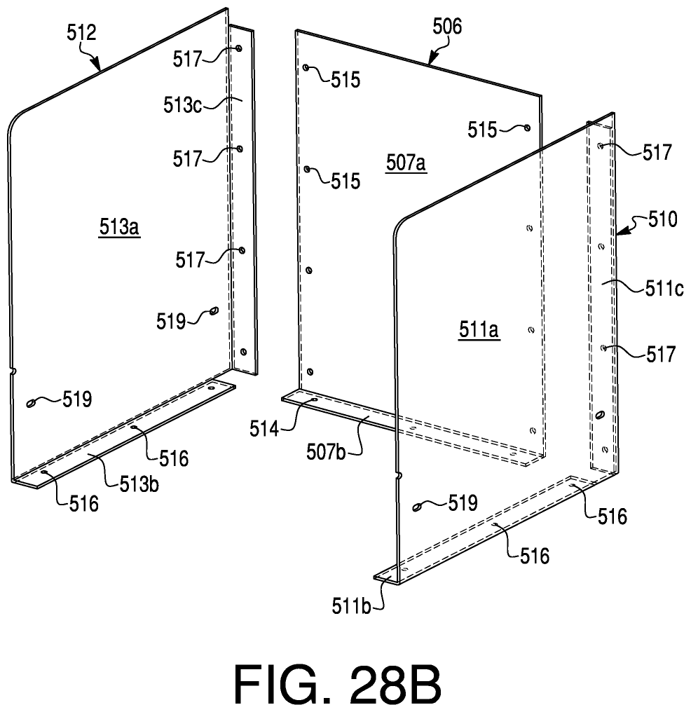

Each of the back, right and left members 506, 510 and 512, respectively, has one or more flanges that extend beyond a main panel. Specifically, the back member 506 includes a planar main panel 507a and a bottom flange 507b that extends from the planar main panel 507a along a side edge thereof, as best shown in FIGS. 28A and 28B. The bottom flange 507b is preferably orthogonal to the main panel 507a. The right member 510 includes a planar main panel 511a, a bottom flange 511b and a side flange 511c, as best shown in FIGS. 28A and 28B. The bottom flange 511b and the side flange 511c extend from the planar main panel 511a along bottom and side edges thereof, respectively. Preferably, each of the bottom flange 511b and the side flange 511c is orthogonal to the main panel 511a. Similarly, the left member 512 includes a planar main panel 513a, a bottom flange 513b and a side flange 513c, as best shown in FIGS. 28A and 28B. The bottom flange 513b and the side flange 513c extend from the planar main panel 513a along bottom and side edges thereof, respectively. Preferably, each of the bottom flange 513b and the side flange 513c is orthogonal to the main panel 513a.

Each of the back, right and left members 506, 510 and 512 is assembled, for example by a consumer or pet owner, by folding a portion of each of the back, right and left members 506, 510 and 512 along pre-formed fold lines 520, creating the bottom flanges 507b, 511b, 513b and side flanges 511c, 513c. Moreover, each of the bottom flanges 507b, 511a, 513a and side flanges 511c, 513c of the back, right and left members 506, 510 and 512 has precut through-holes. Specifically, the bottom flanges 507b of the back member 506 has a plurality of precut through-holes 514, while the planar main panel 507a has a plurality of precut through-holes 515 formed along right and left sides of the planar main panel 507a. Similarly, the bottom flanges 511b, 513b of the right and left members 510, 512 each has a plurality of precut through-holes 514, while the planar main panel 507a each has a plurality of precut through-holes 516, while the side flanges 511c, 513c of the right and left side members 510, 512 each has a plurality of precut through-holes 517.

The bottom flanges 507b, 511b, 513b and side flanges 511c, 513c are configured to align with corresponding through-holes of the adjacent back, right and left members 506, 510 and 512 when assembled. Specifically, the through-holes 515 of the back member 506 are aligned with the corresponding through-holes 515 of the right and left members 510, 512. The back, right and left members 506, 510 and 512 are connected to each other by rivets 528 inserted through the precut through-holes 515, 516 and 517. Moreover, the back, right and left members 506, 510 and 512 are connected to the base member 504 by the rivets 528 inserted through the through-holes 514 and 516 in the bottom flanges 507b, 511b, 513b.

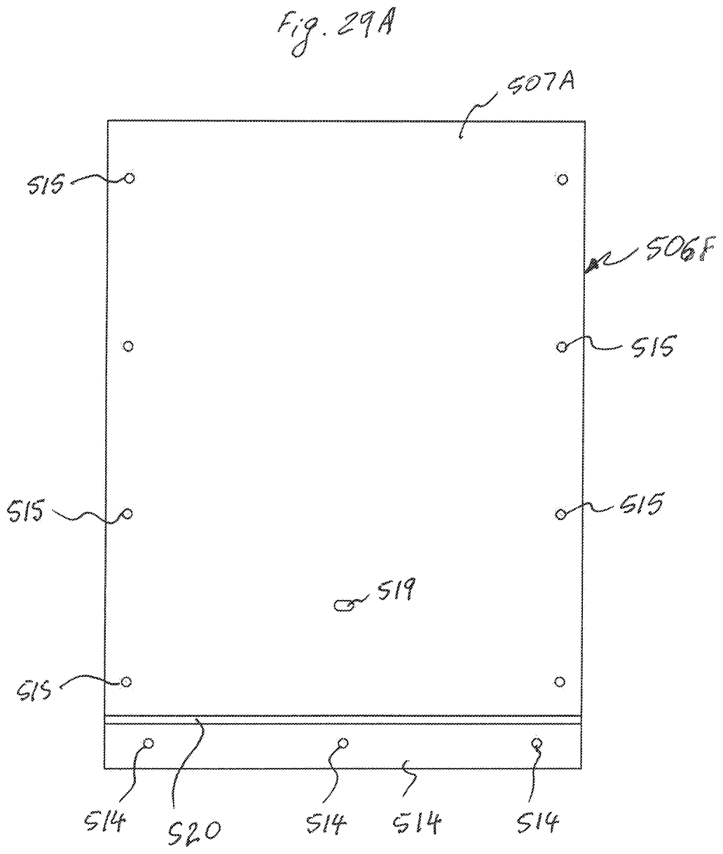

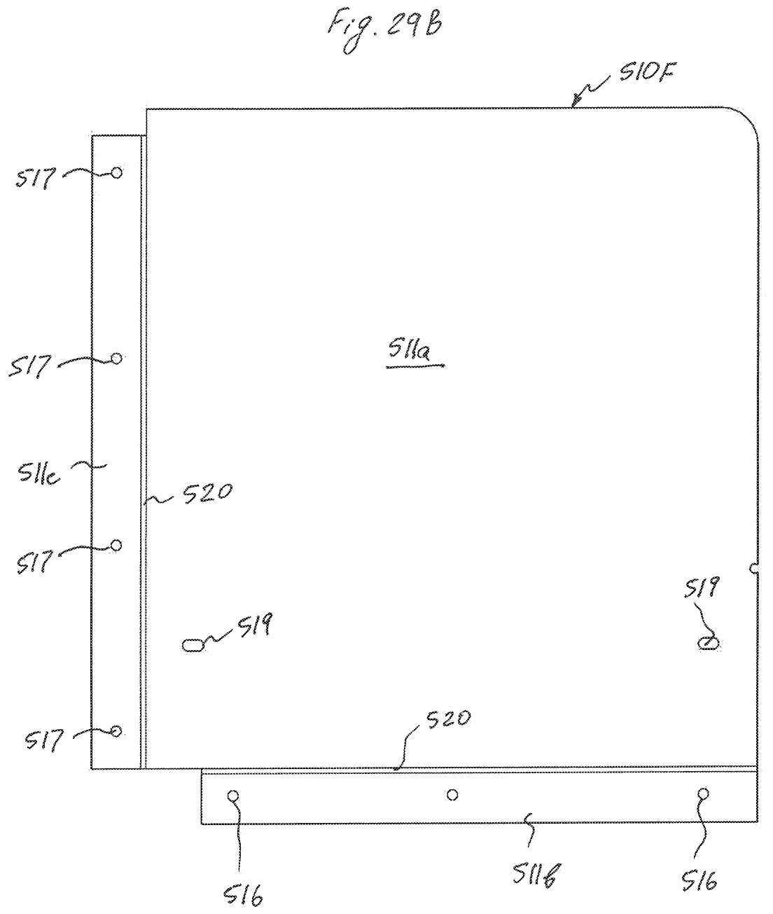

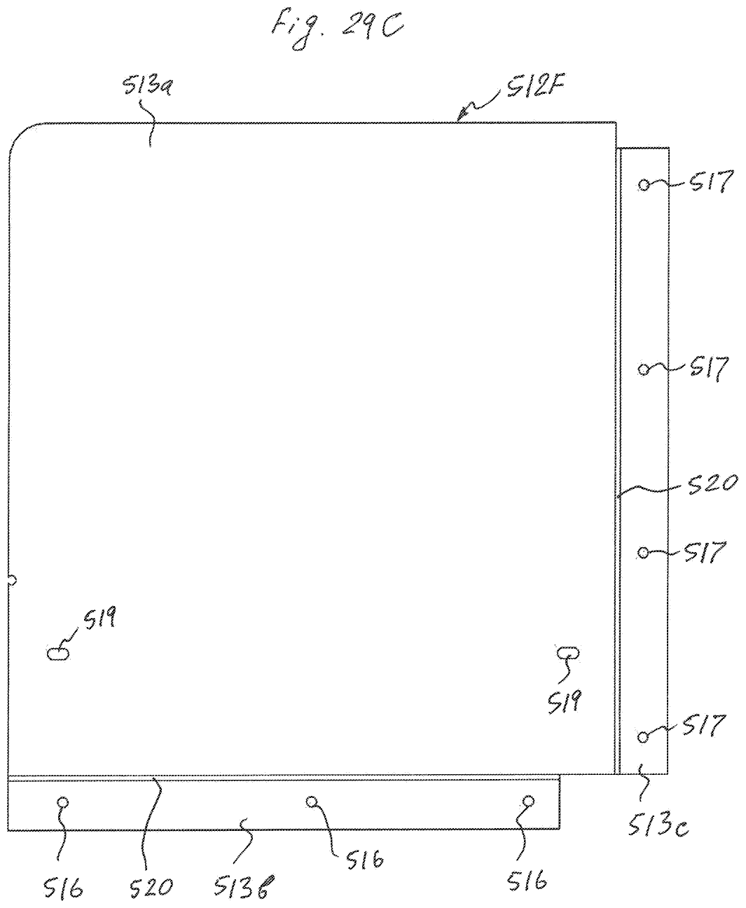

In the fourth embodiment, the bottom, back, left and right members 504, 506, 510 and 512, respectively, are made from four separate flat sheets 504, 506F, 510F and 512F, respectively, of material, preferably corrugated plastic such as Coroplast. Each of the back, left and right separate flat sheets 504, 506F, 510F and 512F is die cut and contains pre-formed fold lines 520, as best shown in FIGS. 29A-29C, forming seams to allow folding each of the separate corrugated sheets 504, 506F, 510F and 512F into one of the back, left and right members 506, 510 and 512, respectively (see FIGS. 28A and 28B).

The through-holes 514 and 516 are formed, such as by punching, in the corrugated plastic sheet 101 for connection of the associated sides with mechanical fasteners, such as rivets, screws, nuts/bolts, etc. The right and left sides 110 and 112 include flange portions 124 and 126, respectively, to allow the right and left sides 110 and 112 to be connected to the bottom side 104, such as with mechanical fasteners and/or adhesive. Attached to the left and right sides 110 and 112 are the vertical rail assemblies (or slotted frame members) 130 and 132, respectively, preferably made from extruded aluminum profile sections and/or injection molded plastic parts. The rail assemblies 130 and 132 are used to attach the front side 108 to the cage system 100, as noted below.

To assemble the fourth embodiment of the cage system 500, the three separate flat sheets 504, 506F, 510F and 512F are folded along the fold lines 520 to form the back, right and left members 506, 510 and 512, respectively, with the bottom flanges 507b, 511b, 513b and side flanges 511c, 513c, as shown in FIG. 28). The back member 506 is then attached to the side flanges 511c, 513c of the right and left side members 510 and 512 with one or more mechanical fasteners, such as the rivets 528 (see FIGS. 25-27, 28A and 28B). The rivets 528 are inserted through the aligned through-holes 515 and 517. Next, the back, right and left members 506, 510 and 512 are connected to the base member 504 by the rivets 528 inserted through the through-holes 514 and 516 in the bottom flanges 507b, 511b, 513b. Through-holes 519 near the base member 504 may be paired with an interior catch tray. In other words, the interior catch tray is constrained by rivets through the aligning through-holes. Alternatively, any other mechanical fasteners, such as screws, nuts/bolts, etc., and/or adhesive may be used.

The right and left members 510 and 512 are further joined by a crossbar (or divider profile) 144 and the right and left rail assemblies 130 and 132. The crossbar 144 connects the right and left members 510 and 512 across a front face of the animal cage system 500. Ends of the crossbar 144 are secured with screws into premade slots in the press-fit mating parts (or front middle joints) 162, as best shown in FIGS. 5 and 6. The vertical rail assemblies 130 and 132 fit around corners of the animal cage system 500 made by intersections of the side members 510, 512 and the base member 504. The vertical rail assemblies 130 and 132 retain the shape of the back and side members 506, 510, 512. The vertical rail assemblies 130 and 132 are fastened to the Coroplast plastic of the right and left members 510 and 512 by self-tapping screws through precut holes of the rail assemblies 130 and 132.

The top side 502 of the animal cage system 500 preferably includes a perimeter (or top) frame 134 with a mesh screen or plastic material 135 filling the open area 136 inside the top frame 134 (see FIG. 25). The corner joints 154 of the top frame 134 retain the rectangular shape of the animal cage system 500. Top edges of the Coroplast main panels 507a, 511a, 513a slide into slots in the top frame 134. The top frame 134 is fastened to the Coroplast by self-tapping screws through precut holes of the top frame 134. The mesh screen of the top side 502 allows for ventilation of the animal cage system 500. The mesh screen also allows for vital environmental control such as, UV lights, heat lamps, and fogging machines. The holes 164 (best shown in FIG. 5) located near the front of the top side 502 are made for optional installation of misting nozzles or for any other plumbing/wiring.

As noted above, the front member 508 of the habitat 500 is structurally similar to the front side 108 of the animal cage system 100 and comprises top and bottom portions 116 and 118, respectively, forming two doors, as best shown in FIG. 6. The top door 116 is a clear plastic or glass. The top door 116 has a thin perimeter frame 140t to optimize viewing space. The bottom door 118 has a mesh screen within the perimeter frame 140b. The mesh screen allows for ventilation of the habitat 500. The doors 116 and 118 are restrained by a vertical rod (or metal hinge pin) 160, as best shown in FIG. 12. The hinge pin 160 is inserted from the top left and slides through circular openings on a left edge of each of the doors 116 and 118. This creates a hinge for the doors to easily open and close. Each of the doors 116 and 118 is restrained in a closed position by a simple latch on a front right edge of the habitat 500.

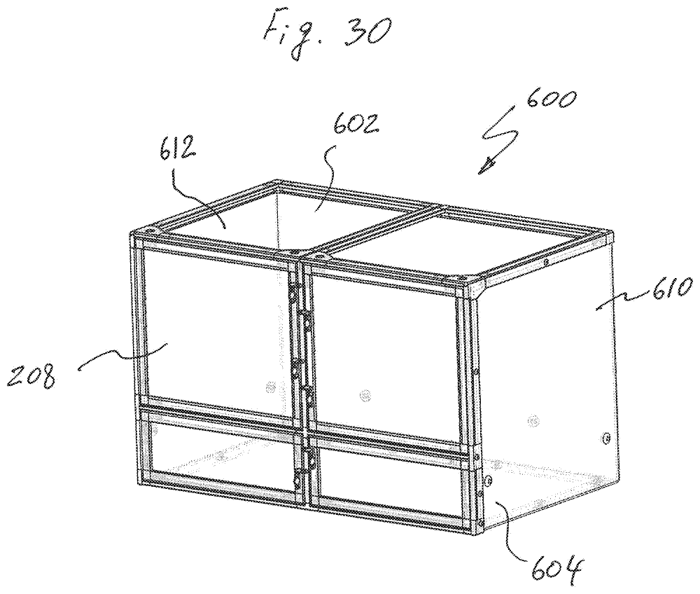

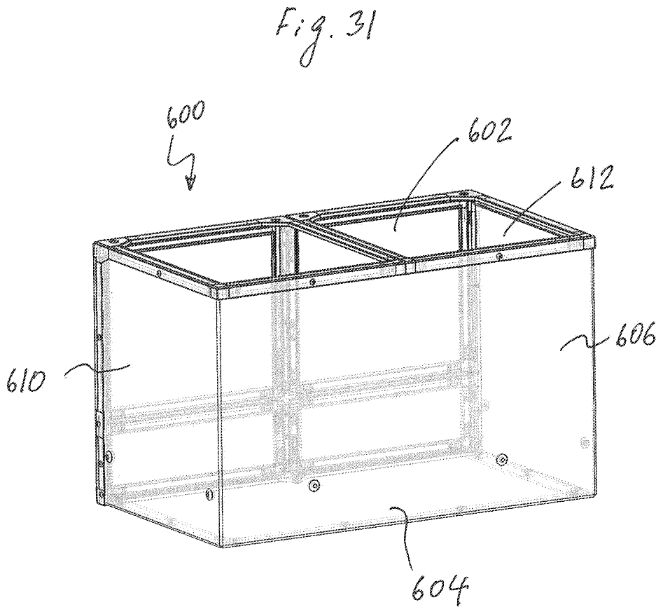

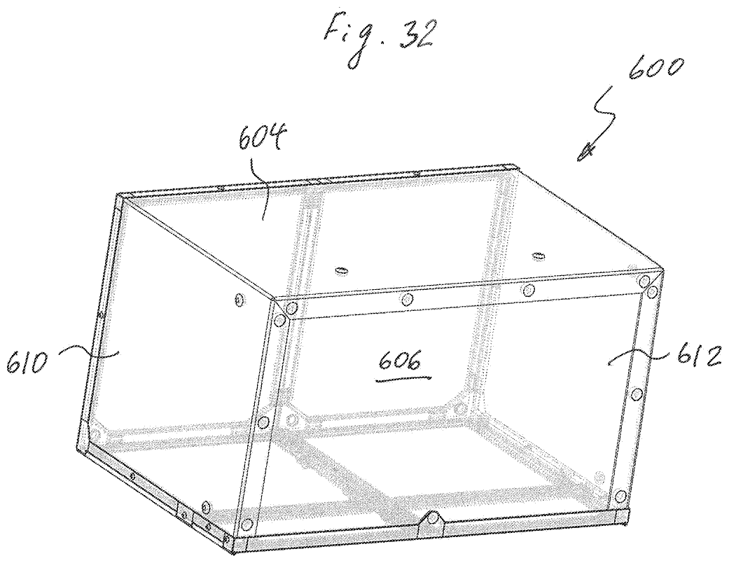

FIGS. 30-32 show an animal cage system (or habitat) 600 according to a fifth exemplary embodiment, referred to herein as a double cage system. In the interest of brevity, reference characters in FIGS. 30-32 that are discussed above in connection with FIGS. 1-29C are not further elaborated upon below, except to the extent necessary or useful to explain the additional embodiments of FIGS. 30-32. Modified components and parts are indicated by the addition of a hundred to the reference numerals of the components or parts according to the fourth exemplary of the present invention.

The double cage system 600 is similar to the double cage system 200 of the third embodiment best shown in FIGS. 13-16. The double cage system 600, when assembled, is a six-sided rectangular box including a top member (or top side) 602, a bottom (or base) member (or bottom side) 604, a back member (or back side) 606, a front member (or front side) 208, a right member (or right side) 610 and a left member (or left side) 612. Contrary to the double cage system 200, the back member 606 is a one-continuous piece rear member. In other words, the double cage system 600 is made of the right member 610, the left member 612 and the one-piece rear member 606 formed separately. Similarly, the bottom side 604 of the double cage system 600 includes a one-piece bottom member 604.

The back side 606, right side 610 and left side 612 are solid members, preferably made from corrugated plastic sheet material of about 4 mm in thickness, such as Coroplast. Each of the base member 604, the back member 606, the right member 610 and the left member 612 are formed separately from each other and fastened to each other during assembly of the animal cage system 600 by appropriate means, e.g., mechanical fasteners, such as rivets, screws, nuts/bolts, etc., and/or adhesive. The front member 608 is structurally similar to the front member 208 of the double cage system 200 according to the third embodiment best shown in FIGS. 13-16.

Although certain presently preferred embodiments of the invention have been specifically described herein, it will be apparent to those skilled in the art to which the invention pertains that variations and modifications of the various embodiments shown and described herein may be made without departing from the spirit and scope of the invention. Accordingly, it is intended that the invention be limited only to the extent required by the appended claims and the applicable rules of law.

What is claimed is:

1. A cage system being in the form of a rectangular box comprising:
a top member and a bottom member opposing the top member;
a front member and a back member opposing the front member and connecting the top and bottom members;
a right member connecting the front and back members and a left member opposing the right member and connecting the front and back members, the back, left and right members formed separately from each other; and
mechanical fasteners or adhesive fastening the back, left and right members to each other;
each of the back, left and right members made of a single solid sheet material;
the front member divided into a top portion and a bottom portion, at least the top portion including a first door hingedly connected to one of the left and right members and securable to another of the left and right members.

2. The cage system of claim 1, wherein the sheet material is corrugated plastic.

3. The cage system of claim 1, wherein each of the bottom, back, left and right members are made from a single sheet of material formed separately from the single sheet of material of the other of the bottom, back, left and right members.

4. The cage system of claim 1, wherein the top member includes a top frame and a mesh screen or clear plastic material filling the area inside the top frame.

5. The cage system of claim 4, wherein the top frame is made of linearly extending aluminum profile sections connected at corners thereof by molded plastic joints.

6. The cage system of claim 1, wherein a plurality of boxes are interconnected in vertical or horizontal relation.

7. The cage system of claim 1, wherein an interior catch tray is disposed along the bottom member to allow waste to be removed from the box.

8. The cage system of claim 1, wherein the back member includes a planar main panel and a bottom flange that extends from the planar main panel along a side edge thereof.

9. The cage system of claim 8, wherein the right member includes a planar main panel, a bottom flange and a side flange, and wherein the bottom flange and the side flange extend from the planar main panel along bottom and side edges thereof, respectively

10. The cage system of claim 9, wherein the left member includes a planar main panel, a bottom flange and a side flange, and wherein the bottom flange and the side flange extend from the planar main panel along bottom and side edges thereof, respectively.

11. The cage system of claim 10, wherein the bottom member is attached to the bottom flanges of the back, left and right members by the mechanical fasteners or adhesive.

12. The cage system of claim 10, wherein the side flanges of the left and right members are attached to the main panel of the back member by the mechanical fasteners or adhesive.

13. The cage system of claim 1, wherein the first door comprises a perimeter frame and a mesh screen or clear plastic material filling the area inside the frame.

14. The cage system of claim 13, wherein the first door is hingedly mounted to a rail assembly on the left or right member.

15. The cage system of claim 10, wherein the perimeter frame is made of linearly extending aluminum profile sections connected at corners thereof by molded joints.

16. The cage system of claim 1, wherein a divider profile attaches to rail assemblies on front edges of the left and right members.

17. The cage system of claim 1, wherein the bottom portion comprises a second door or a tray.

18. The cage system of claim 17, wherein the first door is hingedly mounted to a first rail assembly on the left member, and the second door is hingedly mounted to a rail assembly on the right member.

19. A method for making an animal cage system, comprising the steps of:
a. providing separate flat sheets of material cut to provide a left member, a back member and a right member;
b. folding each of the separate flat sheets to form the left, back and right members;
c. fastening the back, left and right members to each other by mechanical fasteners or adhesive;
d. attaching the bottom member to the back, left and right members;
e. attaching a top member to the back, left and right members;
f. attaching rail assemblies on front edges of the left and right members;
g. attaching a divider profile to the rail assemblies on the front edges of the left and right members, the divider profile dividing the front member into a top portion and a bottom portion; and
h. hingedly mounting a first door to one of the rail assemblies so as to form a front member, the first door occupying the top portion of the front member.

20. The method of claim 19, wherein the top member comprises a top frame and a mesh screen or clear plastic material filling the area inside the top frame.
